(19) United States
(12) Patent Application Publication
(10) Pub. No.: US 2024/0330736 A1
(43) Pub. Date: Oct. 3, 2024

(54) RESOURCE-EFFICIENT PULSE-BASED VARIATIONAL QUANTUM ALGORITHM

(71) Applicant: INTERNATIONAL BUSINESS MACHINES CORPORATION, ARMONK, NY (US)

(72) Inventors: Panagiotis Barkoutsos, Zurich (CH); Bibek Babu Pokharel, Los Angeles, CA (US); Daniel Josef Egger, Zurich (CH); Ivano Tavernelli, Zurich (CH); Laurin Elias Fischer, Zurich (CH); Igor Sokolov, Clarens (CH)

(21) Appl. No.: 18/194,729

(22) Filed: Apr. 3, 2023

(51) Int. Cl. G06N 10/60; G06F 9/50; G06N 10/20

(52) U.S. Cl. CPC G06N 10/60; G06F 9/5033; G06N 10/20

(57) ABSTRACT

A method, computer system, and a computer program product for a resource-efficient pulse-based variational quantum circuit running on a selected quantum hardware to solve a given predefined problem. The present invention may include controlling an execution of a plurality of different quant controlling an execution of a plurality of different quantum circuits using the selected quantum hardware for the given predefined problem to be solved, evaluating a performance of each of the plurality of different quantum circuits, selecting a best performing one of the plurality of quantum circuits, generating a pulse sequence having a pulse schedule tailored to the selected quantum hardware and the given problem for the best performing one of the plurality of the different quantum circuits, and determining a simplified pulse schedule of the pulse sequence, thereby producing an efficient pulse-based schedule that acts as a pulse-based variational form for the best performing quantum circuit.

### BACKGROUND

The invention relates generally to the field of quantum computing, and more specifically, to a computer-implemented method for a resource-efficient pulse-based variational quantum circuit running on a selected quantum hardware to solve a given problem. The invention relates further to a quantum information processing system for executing a resource-efficient pulse-based variational quantum circuit running on a selected quantum hardware to solve a given problem, and to a computer program product.

Quantum computing remains one of the hottest topics in computer science, in research and the industry. Classical digital computers and/or processors are slowly reaching their physical limitations, so research is looking for new ways to address mathematical and other problems that cannot be solved by classic von-Neumann machines due to the physical limitations in terms of structure size, power consumption and ultimately speed of processing.

Quantum computing is thus the basis to reach quantum advantage, i.e., a real advantage in addressing very complex competition or tasks in reasonable times. As is well known, conventional computers encode process information in bits, i.e., “1”s and “0”s. Quantum computers, on the other hand, are based on so-called qubits which operate according to two key principles of quantum physics: superposition and entanglement. Superposition describes a situation that each qubit can represent both a “1” and a “0” inference between possible outcomes for an event. Entanglement means that qubits in superposition can be correlated with each other in a non-classical way, i.e., the state of one qubit, whether it is “1” or “0” or both, can depend on the state of another, and that there is more information contained in qubits when they are entangled compared to single ones.

In general, a quantum state is the mathematical description of the state of an atomic or subatomic-size system. This is described as a vector in a vector space over complex numbers, generally known as the Hilbert space. A quantum state can thereby describe any properties of the quantum particle or system of quantum particles, e.g., that position, momentum, quintessential phenomenon like quantum spins, and so on. Some of these properties are continuous variables and are therefore represented by vectors in the infinite-dimensional Hilbert space; position and momentum as variables are examples of this. However, other properties such as the spin of a particle can only assume definitive many quantized values and are therefore finished-dimensional. For example, the spin-part of the state of a quantum system with “n” electrons can be a state inside a 2ⁿ dimensional Hilbert space. Hence, the Hilbert space for “n” qubit quantum computer scales as 2ⁿ. Intuitively, each qubit in a quantum computer is somehow equivalent to a bit in the classical digital computer system. However, several qubits together in a system can explore a full “n”-dimensional Hilbert space instead of requiring 2ⁿ classical bits to do the same. Hence, superposition and entanglement are two unique quantum properties that qubits possess over their classical counterparts.

Now, Variational Quantum Eigensolvers (VQE) have successfully been used as quantum heuristics used in quantum chemistry and optimization problems. Thereby, the goal is to find optimal parameters of a parametrized quantum state such that an expectation value of interest is minimized. This goal can be achieved using a hybrid quantum-classic computing loop, where quantum states are prepared on a quantum computer and the optimization of parameters is done on the classical digital computer system.

Known is also a pulse-based control for a lower-level manipulation of quantum circuits—i.e., physical qubits—where the frequency, duration, shape and amplitude of the pulses can be precisely controlled. This has been investigated in many ways because all traditional quantum gates are built with pulses, typically microwave pulses.

There are some disclosures related to a computer-implemented method for a variational quantum circuit running on a selected quantum hardware. For example, one disclosure suggests a method and an apparatus for determining a quantum circuit by sampling an initial circuit unit pool according to an initiative sampling manner to obtain initial K groups of circuit units and constructing and generating initial K candidate quantum circuits. The method also comprises determining a performance evaluation index corresponding to the initial K candidate quantum circuits and updating the initial sampling method and is circuit unit in the initial circuit unit pool based on the performance evaluation index, to obtain an updated sampling manner and an updated circuit unit pool.

Additionally, it has been suggested that variational quantum circuits (VQC) have limited flexibility and expressability due to a limited number of parameters, e.g., only one paramedic can be trained in one rotational gate if the quantum circuit is used for quantum machine learning. On the other side, it was observed that quantum pulses are lower than quantum gates in the stack of quantum computing and offers more controlled parameters. Inspired by the promising performance of VQC, variational quantum pulses (VQP) may be proposed, a paradigm to directly trade quantum pulses for learning tasks.

In the absence of fault-tolerance of quantum devices, VQEs art one of the most promising avenues for a useful application of quantum computers. The VQE may provide a unique testbed to explore the opportunities of near-term quantum devices for various applications. An effective VQE for instance may predict chemical reactions and determine molecular priorities.

An effective VQE must be optimal, both, in terms of the quantum operations employed and the classical optimization performed. As state-of-the-art VQEs rely on quantum gates, a hardware-level optimization of pulses is crucial to make a better usage of the limited quantum resources (e.g. T₁ and T₂ times, i.e., coherence and de-coherence time). This in turn would lead to more accurate and faster calculations of, e.g., chemical molecules.

Hence, the disadvantage of known approaches may be the weaknesses in finding an optimized quantum circuit ansatz including a related control of the quantum circuit. Methods proposed so far have been purely hypothetical and lack specific details. Furthermore, none of them have attempted to implement the proposals on quantum hardware.

Consequently, there may be a need to overcome these limitations, in particular, in determining an optimized quantum circuit ansatz with a related control mechanism for the quantum circuit.

### SUMMARY

Embodiments of the present invention disclose a method, computer system, and a computer program product for a resource-efficient pulse-based variational quantum circuit running on a selected quantum hardware to solve a given predefined problem. The present invention may include controlling an execution of a plurality of different quant controlling an execution of a plurality of different quantum circuits using the selected quantum hardware for the given predefined problem to be solved, evaluating a performance of each of the plurality of different quantum circuits, selecting a best performing one of the plurality of quantum circuits, generating a pulse sequence having a pulse schedule tailored to the selected quantum hardware and the given problem for the best performing one of the plurality of the different quantum circuits, and determining a simplified pulse schedule of the pulse sequence, thereby producing an efficient pulse-based schedule that acts as a pulse-based variational form for the best performing quantum circuit.

According to another aspect of the present invention, a quantum information processing system for executing a resource-efficient pulse-based variational quantum circuit running on a selected quantum hardware to solve a given problem, may be provided. The system may comprise a digital processor operationally coupled to a digital memory which stores instructions, which, when executed, may control the following components: an execution environment for the selected quantum hardware adapted for executing a plurality of different quantum circuits using the selected quantum hardware for the given predefined problem to be solved, an evaluating unit, controlled by a digital processor, the evaluation unit being operational to evaluate a performance of each of the plurality of quantum circuits, and a selection module selecting, controlled by the digital processor, the selection module being operational to select a best performing one of the plurality of quantum circuits.

Additionally, the system may comprise a generator, controlled by the digital processor, the generator being operative for generating a pulse sequence having a pulse schedule to the selected quantum hardware and the given problem for the best performing quantum circuit of the plurality of different quantum circuits, and a determination unit, controlled by a digital processor, the determination unit being operational to determine a simplified pulse schedule, thereby producing an efficient pulse-based schedule that acts as a pulse-based variational form for the best performing quantum circuit.

The proposed computer-implemented method for a resource-efficient pulse-based variational quantum circuit running on selected quantum hardware to solve a given problem may offer multiple advantages, technical effects, contributions and/or improvements:

The pulse-based ansatz or pulse-based approach is used to improve the performance of variational quantum algorithms. Thereby, efficient parametrized pulse schedules for variational quantum algorithms are used to make new unitary operations equivalent to gates to generate the ground state of the system of interest—i.e., representing a given problem.

To prepare the ground state of the problem Hamiltonian, a parametrized pulse schedule is selected advantageously. Then, the prepared ground state energy may be measured and a classical feedback loop may evaluate this energy to update the pulse parameters in a hybrid digital/quantum computing loop.

The optimization algorithm used in the classical feedback loop is arbitrary. The parametrization of the pulses in such a way may only be possible with a fast and controllable interface between the pulse specification and the classical optimization scheme. Exemplary, IBM's Qiskit Pulse module may allow such an interface. PulseVQE may build upon this functionality by defining physically meaningful and algorithmically efficient parametrized schedules.

In one implementation, a parametrization has been demonstrated for the cross-resonance pulse which is normally used to perform the CNOT gate, which is a two qubit gate. While all quantum circuits are pulse schedules, the parametrized cross-resonance reassembles a CNOT only for a specific choice of parameters.

Contrary to prior art approaches-which have focused almost entirely on VQEs using quantum circuits, which limited performance—the concept proposed here may improve the VQE by running the optimization on simplified pulse schedules that do not comprise the built-in unnecessary pulse constraints the schedules to generate the backend's basis gates.

Furthermore, the concept proposed here may make it possible to run pulse-based VQEs on a cloud-based quantum computer as it moves part of the pulse calibration into the VQE algorithm.

In contrast to most work on variational quantum algorithms using parametrized circuits as building blocks, the here proposed solution is based on extending these building blocks to feasible and scalable pulse schedules which extends—i.e., generalizes—the older approach. Therefore, it may allow the quantum device to make a better usage of coherence times. This may accelerate the path to a quantum advantage. Indeed, the same quantum state achieved by a CNOT-based quantum circuit may be reached in a minimal amount of time when, e.g., parametrizing the duration and amplitude of the cross-resonance gate.

Furthermore, the first two steps of the proposed concept may keep the number of para meters of a variational pulse-based implementation similar to those of the circuit-based approach. The simplification step may allow removing unnecessary parameters while the pulse adding step may allow adding the controls needed for controllability.

Additionally, the proposed concept may deviate from the digital approach of known VQEs by using the quantum hardware and in an almost analog fashion.

In contrast to state-of-the-art techniques for creating cross-resonance gates, having focused on optimizing these gates to perform the entangling operation CNOT, optimizing the cross-resonance gates to perform state preparation may lead to quantum operations that are better suited for variational algorithms.

Additionally, in particular practical advantages, will also be discussed in the context of FIGS. 10, 11 and 12. Apart from the specific examples below, it should also be highlighted here the aspect of how to reduce the complexity of a pulse-based ansatz. At the pulse level there is an almost infinite way to parameterize a schedule. In the extreme case, every sample of the arbitrary waveform generator creating the pulses may be a free parameter that the classical optimizer must optimize. However, if the number of parameters to optimize is too high, the classical optimizer will take a very long time to navigate the excessively large optimization landscape. The concept proposed here provides a framework to create efficient pulse-based variational forms without having to deal with all the complexity and freedom that the pulse-level has to offer.

In the following, additional embodiments of the inventive concept—applicable for the method as well as for the system—will be described.

According to an advantageous embodiment of the method, the evaluation of the performance of each of the plurality of quantum circuits may also comprise simplifying the given problem. The given problem may thereby be simplified by removing at least one of a plurality of sub-systems of the problem or by reducing of the number of Pauli operators used to address the given problem. This is also illustrated in FIG. 2 (description see below).

According to another advantageous embodiment of the method, the determination of the simplified pulse schedule may comprise at least one selected out of the group comprising: (i) removing at least a pulse from the pulse schedule, (ii) merging at least two pulses in the pulse schedule, (iii) adding pulses to the pulse schedule, and (iv) changing a shape of the pulse. Thereby, typically one or more echoes of the signals may be removed or reduced. Changing the shape of the pulse may also comprise a reduction in the signal length. This way, less time for the execution by the quantum circuit may be required.

According to a further advantageous embodiment of the method, the determining of the simplified pulse schedule may comprise using a single Gaussian pulse as a replacement for more complex pulse shapes. This again may reduce the complexity of the scheduled pulse and may also contribute to a time reduction for the pulses and thus to a time reduction of an excitation of the relevant physical cubit.

Hence, and according to a related preferred embodiment of the method, the determination of the simplified pulse schedule may comprise reducing an active time for a scheduled pulse. Consequently, this may lead to shortened schedules and thus to higher performance of the implementation.

According to a permissive embodiment of the method, the selected quantum hardware may comprise a physical two-qubit gate. These may be used advantageously to perform the known CNOT operation, also known as controlled NOT gate or C-NOT. It can be used to entangle and disentangle qubits. Because any quantum circuit may be simulated to an arbitrary degree of accuracy using a combination of CNOT gates and single qubit rotations, this physical two-bit qubit gate is of high interest.

According to an optional embodiment of the method, the selected quantum hardware may use error correction and/or error mitigation. This may be advantageous, because noise may reduce the accuracy of the evaluation of a quantum circuit which may lead to unexpected results. Error correction and/or error mitigation may reduce this weakness similar to error correction schemes on classical digital computers.

According to a further developed embodiment of the method, the quantum circuit—in particular, the pulse-based variational quantum circuit(s)—may be used for a simplified and optimized physical two-qubit gate and a determination of a molecular energy level of a molecule. This may, e.g., be the ground state of H₂ molecule. However, using more pulse-based variational quantum circuits, more complex molecules may be simulated in their behavior.

According to an interesting embodiment of the method, a COBYLA optimization algorithm—i.e., Constraint Optimization By Linear Approximation—or a SPSA optimization algorithm—i.e., Simultaneous Perturbation Stochastic Approximation—may be used for the determination of parameters of the simplified pulse schedule. It has been proven that these two optimization algorithms may be used successfully for the task described in this document. However, also other optimization techniques may be used for simplified pulse schedules.

According to a further useful embodiment of the method, the COBYLA optimization algorithms or the SPSA optimization algorithm may respectively be performed by a digital processor. These classical processes may be well suited for a determination of the optimization in a comparably short time frame. Hence, the operation of the digital computer and the quantum hardware executing the quantum circuit(s) may be combined in a loop process, wherein the digital computer running the optimization process does not slow down the quantum circuit.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain means for storing, communicating, propagating or transporting the program for use, by, or in connection, with the instruction execution system, apparatus, or device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, to which the invention is not limited.

Preferred embodiments of the invention will be described by way of example only, and with reference to the following drawings:

FIG. 1 depicts a block diagram of an embodiment of the inventive computer-implemented method for a resource-efficient pulse-based variational quantum circuit running on a selected quantum hardware to solve a given problem;

FIG. 2 depicts an exemplary illustration for simplifying a given predefined problem according to at least one embodiment;

FIG. 3 depicts a block diagram of an embodiment of a cross resonance gate according to at least one embodiment;

FIG. 4 depicts a continuation of FIG. 3 and an exemplary resonance signal diagram according to at least one embodiment;

FIG. 5 depicts a more implementation-near flowchart detailing the steps of the proposed concept according to at least one embodiment;

FIG. 6 depicts an exemplary selection process of a best performing quantum circuit according to at least one embodiment;

FIG. 7 depicts a diagram of a quantum circuit pulse scheduled according to at least one embodiment;

FIG. 8 depicts a result when removing echoes and rotaries according to at least one embodiment;

FIG. 9 depicts the proposed concept as a loop process according to at least one embodiment;

FIG. 10 depicts a practical proof of concept for the inventive concept according to at least one embodiment;

FIG. 11 depicts another aspect of the practical proof of concept for the inventive concept according to at least one embodiment;

FIG. 12 shows a practical diagram illustrating an impact of the proposed concept.

FIG. 13 depicts an exemplary qubit operation that may be utilized in various embodiments;

FIG. 14 depicts an exemplary qubit operation that may be utilized in various embodiments;

FIG. 15 depicts a block diagram of an embodiment of the inventive quantum information processing system for executing a resource-efficient pulse-based variational quantum circuit running on the selected quantum hardware to solve a given problem; and

FIG. 16 depicts a block diagram of an exemplary computing environment according to at least one embodiment.

### DETAILED DESCRIPTION

The following described exemplary embodiments provide a system, method, and program product for a resource-efficient pulse-based variational quantum circuit running on a selected quantum hardware to solve a given predefined problem. As such, the present embodiment has the capacity to improve the technical field of quantum computing by determining an optimized quantum circuit ansatz with a related control mechanism for the quantum circuit. More specifically, the present invention may include controlling an execution of a plurality of different quant controlling an execution of a plurality of different quantum circuits using the selected quantum hardware for the given predefined problem to be solved, evaluating a performance of each of the plurality of different quantum circuits, selecting a best performing one of the plurality of quantum circuits, generating a pulse sequence having a pulse schedule tailored to the selected quantum hardware and the given problem for the best performing one of the plurality of the different quantum circuits, and determining a simplified pulse schedule of the pulse sequence, thereby producing an efficient pulse-based schedule that acts as a pulse-based variational form for the best performing quantum circuit.

A quantum circuit description of a variational quantum algorithm (i.e., quantum circuit) is sub-optimal when restricted to a finite set of basic gates such as {√2}, R_{Z}(θ), CNOT)}.

Minimizing an expectation value which corresponds to finding the ground state of a given Hamiltonian is computationally challenging and of immense interest. The effectiveness of the VQE used to involve these problems is tied to how the parametrized quantum circuits are generated and how these parameters can generate non-trivial quantum states.

The parametrization of circuits proposed in prior art is done at the gate level, by performing rotations of logical qubits according to angles (used as variational parameters). These quantum circuits often make a pool usage of the coherence time as they fix the duration of the quantum circuit beforehand. They are also typically built from a set of backend-provided basis gates optimized to remove both unitary and non-unitary errors however, evidence suggest that variational algorithms are robust to certain unitary errors. The gate description therefore imposes unnecessary constraints on the controlled pulse in a variational setting. For example, cross-resonance pulse schedules in CNOT gate are designed to remove unwanted unitary terms such as IY and IZ.

There is a strong parallel between optimal control and variational algorithms, this is however not easy to exploit i.e., a real challenge. The over-parametrized nature of pulse-level ansatzes makes them almost impossible to implement in variational algorithms. In the most extreme case, each sample of the control electronics can be seen as a free parameter. On the other hand, analytic pulse shapes have less parameters but require choosing the right analytic shapes for the correct channels at the right time.

In the context of this description, the following technical conventions, terms and/or expressions may be used:

The term ‘pulse-based variational quantum circuit’ may denote an algorithm being executed by a quantum hardware device wherein the execution of the algorithm is controlled using pulses of electromagnetic radiation.

The term ‘quantum hardware’ may denote any type of quantum computing gate(s). This may be independent of the type of quantum gates used, e.g., physical super conducting qubit devices, an ion trap quantum system or a quantum-dot system.

The term ‘given problem’ may denote a task to be solved by the quantum hardware, i.e., the quantum gates using a pulse-based quantum circuit.

The term ‘quantum circuit’ may denote an algorithm being executed by dedicated quantum hardware. As example, a quantum circuit acting on qubits may have one wire per qubit and quantum gates acting on one or more qubits.

The term ‘performance’—in particular, the performance of a quantum circuit—may be measured as expressiveness or another characteristic parameter, like reached energy, time to reach an energy equilibrium or the like.

The term ‘plurality of different quantum circuits’ may denote a set of different and distinct quantum algorithms for an execution on the selected quantum hardware.

The term ‘pulse sequence’ may denote a time-based set of, e.g., microwave pulses dedicated to control and the functioning of quantum gates to perform a quantum circuit.

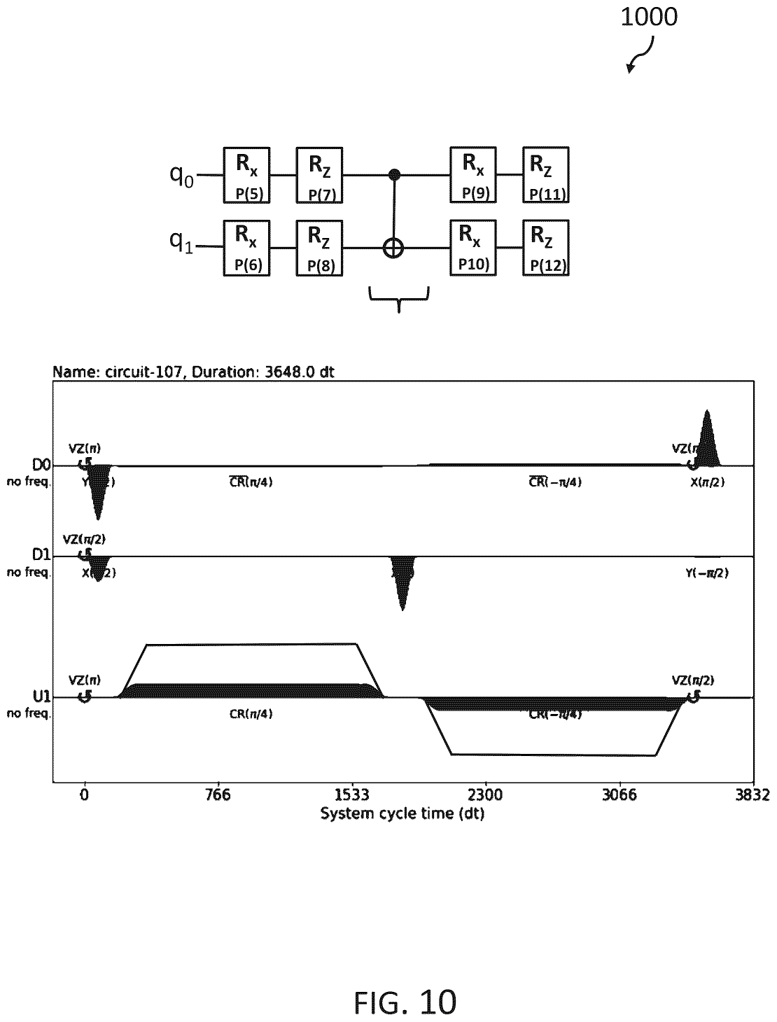

The term ‘simplified pulse schedule’ may denote a pulse schedule that is different and less complex than traditionally used pulse schedules to implement quantum gates. More detailed examples are explained in the context of FIGS. 10 to 12.

The term ‘two-qubit gate’ may denote a quantum hardware system comprising two physical qubits required for a rotation or CNOT operation.

The term ‘COBYLA’ may denote the known Constraint Optimization By Linear Approximation algorithm which is a numerical optimization method for constraint problems were the derivative of the objective function is not known. I.e., COBYLA can find the vector x∈S, S⊆ [symbol] that has the minimal (or maximal) ƒ(x) without knowing the gradient of ƒ.

The term ‘SPSA’ may denote the known Simultaneous Perturbation Stochastic Approximation which is an algorithmic method for optimizing systems with multiple unknown parameters. As the name already says, it is a type of stochastic approximation algorithm. It is well suited to large-scale population methods, adaptive modeling, simulation optimization, and atmospheric modeling.

The term ‘quantum information processing system’ may denote a computing system comprising at least a set of quantum gates, e.g., physical qubit devices like super-conducting qubits with the cross-resonance interaction to implement a CNOT gate, a related control systems, e.g., microwave control and measurement systems, and typically as well a digital (traditional) computer system executing program code for controlling the operation of the quantum gates as well as receiving results from a quantum operation.

In the following, a detailed description of the figures will be given. All instructions in the figures are schematic. Firstly, a block diagram of an embodiment of the inventive computer-implemented method for a resource-efficient pulse-based variational quantum circuit running on a selected quantum hardware to solve a given problem is given. Afterwards, further embodiments, as well as embodiments of the quantum information processing system for executing a resource-efficient pulse-based variational quantum circuit running on a selected quantum hardware to solve a given problem will be described.

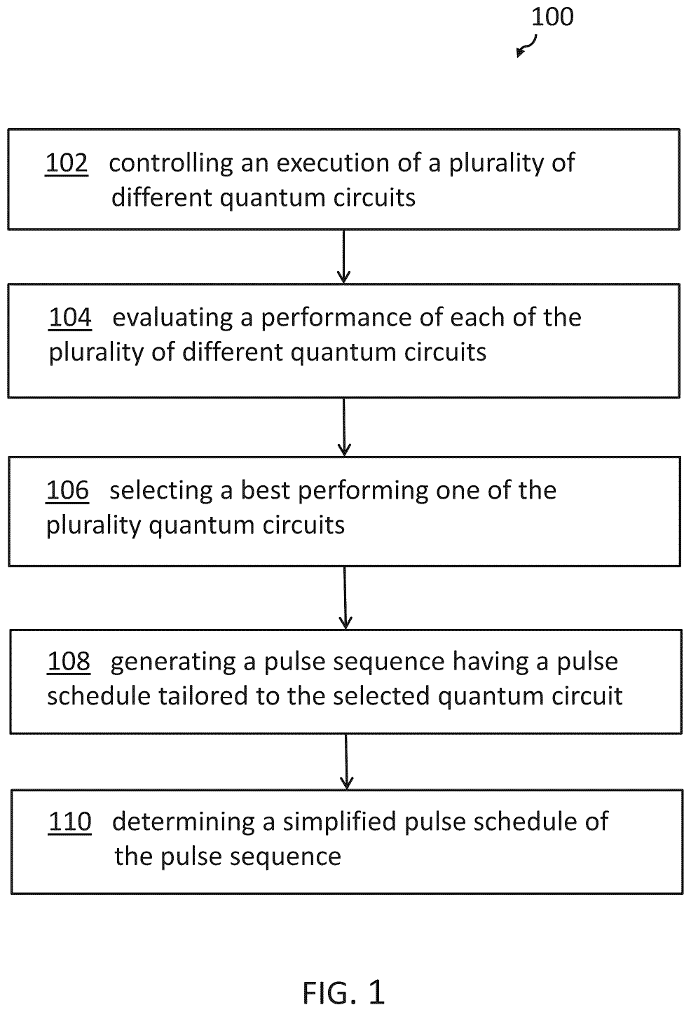

FIG. 1 depicts a block diagram of a preferred embodiment of the computer-implemented method 100 for a resource-efficient pulse-based variational quantum circuit i.e., quantum algorithm—running on a selected quantum hardware to solve a given problem. The problem is predefined and the selected hardware is a super conducting qubit device with a given set of quantum gates. It can also be an ion trap quantum system or a quantum-dot system. The method 100 comprises controlling, 102, an execution of a plurality of different quantum circuits using the selected quantum hardware for the given predefined problem to be solved. At least, this step and the next step may be hybrid steps where the classical or digital computer may be active as well as the quantum hardware.

The method 100 also comprises evaluating, 104, a performance of each of the plurality of different quantum circuits which may be executed using pulse-based variational techniques. Thereby the performance may be determined by measuring how low the energy of quantum hardware system may be after tuning in and/or how fast the equilibrium may be reached.

Optionally, also the given or predefined problem can be simplified, i.e., the problem may be represented by a model with less Pauli terms.

The method 100 may also comprise selecting, 106, a best performing one of the plurality of quantum circuits, generating, 108, in the sense of scheduling a pulse sequence having a pulse schedule tailored to the selected quantum hardware and the given problem for the best performing one of the plurality of different quantum circuits, and determining, 110—also in the sense of scheduling/choosing/selecting—a simplified pulse schedule of the pulse sequence. Thereby an efficient pulse-based schedule may be produced that may act as a pulse-based variational form for the best performing—in particular—variational-quantum circuit. Finally, the pulse-based schedule can be applied to the selected hardware so that the quantum circuit may be executed (not explicitly shown as extra activity).

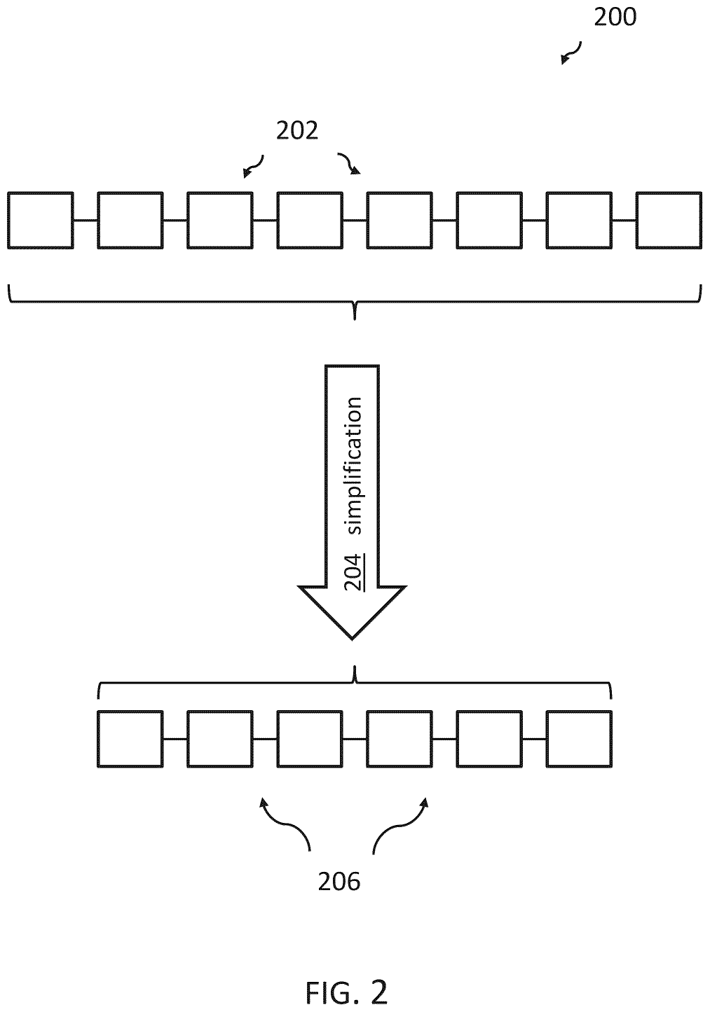

FIG. 2 depicts an exemplary illustration 200 of simplifying the given problem. The given problem and/or predefined problem is symbolized by eight horizontal boxes with single dependencies symbolized by seven lines between the eight boxes. However, also more complex dependency structures may be possible. Each box 202 may symbolize a feature of the given problem.

The simplification 204 may be achieved by taking out a number of features describing the problem which may also lead to taking out dependencies between some of the features. Hence, the problem can be symbolized by the six boxes 206 of the lower line with five linear dependencies of a more complex dependency structure between the features 206 of the simplified problem.

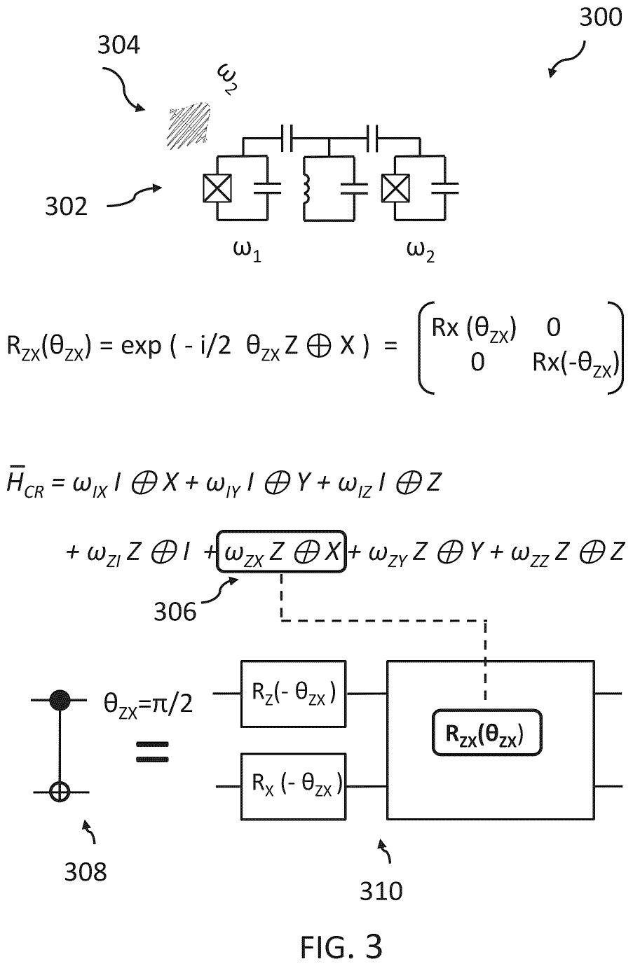

FIG. 3 depicts a block diagram of an embodiment 300 of a cross resonance gate 304 and related mathematical background. The cross resonance gate 304 is shown with two physical qubits (each physical qubit 302 is shown as a square with a black cross, the Josephson junction, in parallel with a capacitor) with two resonance frequencies ω₁ and ω₂. A pulse 304 with frequency ω₂ may be used to drive the qubit with resonance frequency ω₁ thereby creating the cross resonance Hamiltonian.

For a CNOT gate, the component R_{ZX}(θ_{ZX}) gate can be described by the given formula, wherein θ symbolizes the parametrization. The related Hamiltonian is shown aligned below. It shall also be noted that only the term 306 of this equation may be relevant, whereas all other terms can be cancelled to about zero with an appropriate pulse schedule.

The symbolized CNOT gate 308 can then—at the parametrization point π/2—be symbolized as the given partial operators which are shown as 310 in a combined form.

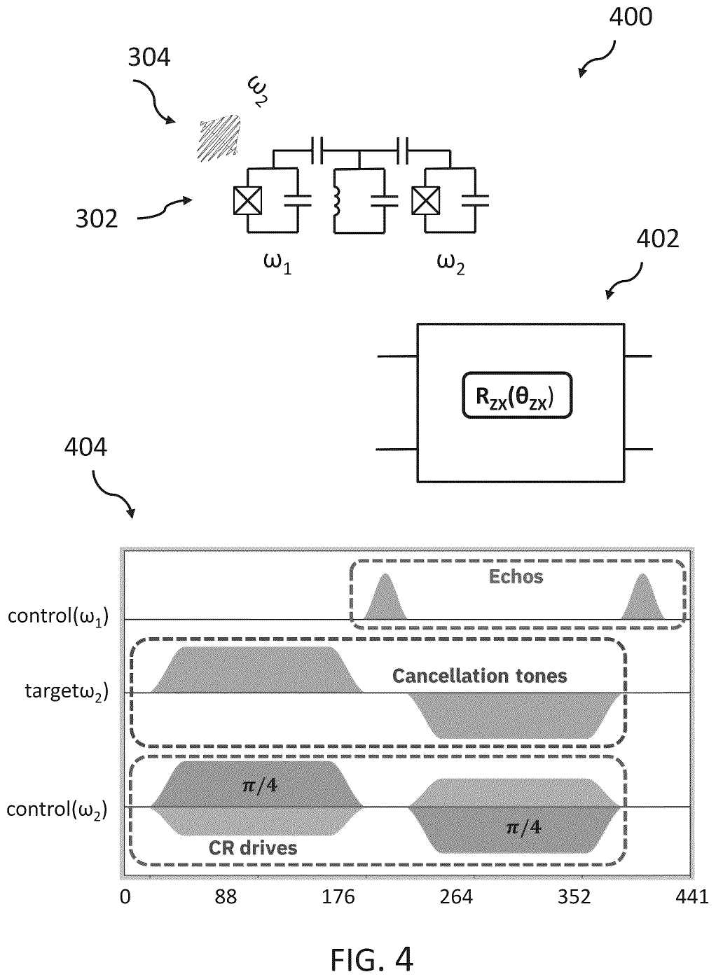

FIG. 4 depicts a continuation 400 of FIG. 3. The cross-resonance gate 304 is shown again as well as for the part of the resulting quantum circuit 402 which is relevant. The resonance signal diagrams are shown as 404, showing echo signals, cancellation tones and π/4 cross resonance drive signals. According to the area theorem, the respective pulse areas define the rotation angle (according to Sundaresan, PRX, Quantum 200 and Sheldon, P R A, 2016).

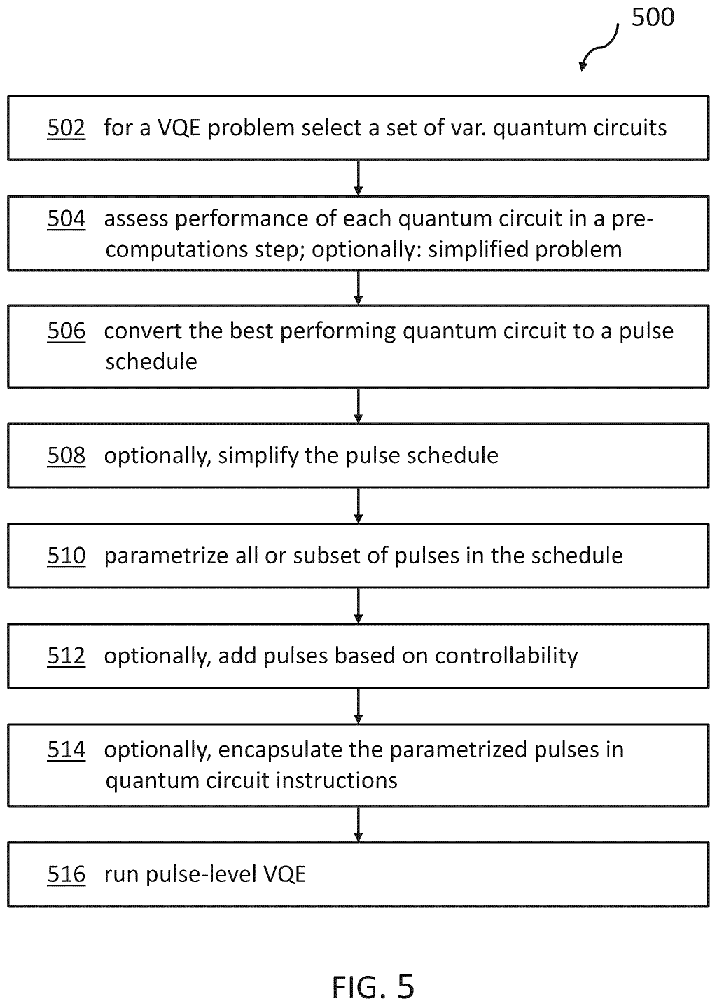

FIG. 5 shows a more implementation-near flowchart 500 detailing the steps of the proposed concept. The activities of this flowchart can be grouped in four steps. Step one comprises the activities 502 and 504. To overcome the vast number of choices in pulse parametrization, a selection methodology based on the performance of a set of quantum circuits may be utilized. I.e., a set of variational quantum circuits may be selected, 502.

In an embodiment of this selection methodology e.g., the expressiveness—or another characteristic parameter, like reached energy, or any other metric of performance in the context of a variational algorithm—of a set of variational quantum circuits and/or ansatzes may be assessed, 504, in a pre-processing step. E.g., the VQE applied to the given or predefined problem of interest—or a simplified version of it—may be carried out on a set of given quantum circuits (i.e., ansatzes) to assess, e.g., the expressiveness of each quantum circuit. The best performing quantum circuit may be selected. Optionally, the problem can also be simplified so that less Pauli operators may be required.

Step 2 of the flowchart 500 comprises the next three activities 506, 508 and 510. The selected circuit from step 1 may be converted, 506, to a pulse schedule. This can, e.g., be done with an instruction scheduling map provided by the backend systems. The pulses in the schedule are then made parametric, 510, e.g., the duration of the cross-resonance tone, its phase and amplitude become variational parameters. This may allow the variational ansatz to trade coherence times usage against unitary errors that are either irrelevant or could be compensated by other variational parameters, e.g., in single-qubit pulses.

Optionally, the pulse schedules can be simplified, 508, e.g., by at least, merging pulses, removing lengthy echo sequences and rotary tones in cross-resonance gates, replacing the sequence R [symbol] (θ₁)\sqrt{X} R_{z}(θ₂)\sqrt{X} R [symbol] (θ₃) by a single Gaussian pulse with a parametric phase and amplitude.

In the third step, and optionally one can add, 512, pulses with parameters to the schedule. This may be done following controllability arguments. For example, one may elect to add a pulse that drives a generator that may be missing from the existing schedule that may be needed to generate SU(2ⁿ) (especially unitary group) in an n-qubit system. Furthermore, and also optionally, the parametrized pulse can be encapsulated, 514, in quantum circuit instructions.

The last step is marked mainly by activity 516. Here, the retained parametrized pulse-schedule is used to run the VQE on the problem of interest. However, optionally, the parametrized pulse can be encapsulated, 514, in quantum circuit instructions if required by the controlled stack. Furthermore, the optimal parameters from the circuit ansatz assessment step may be used as initial parameters.

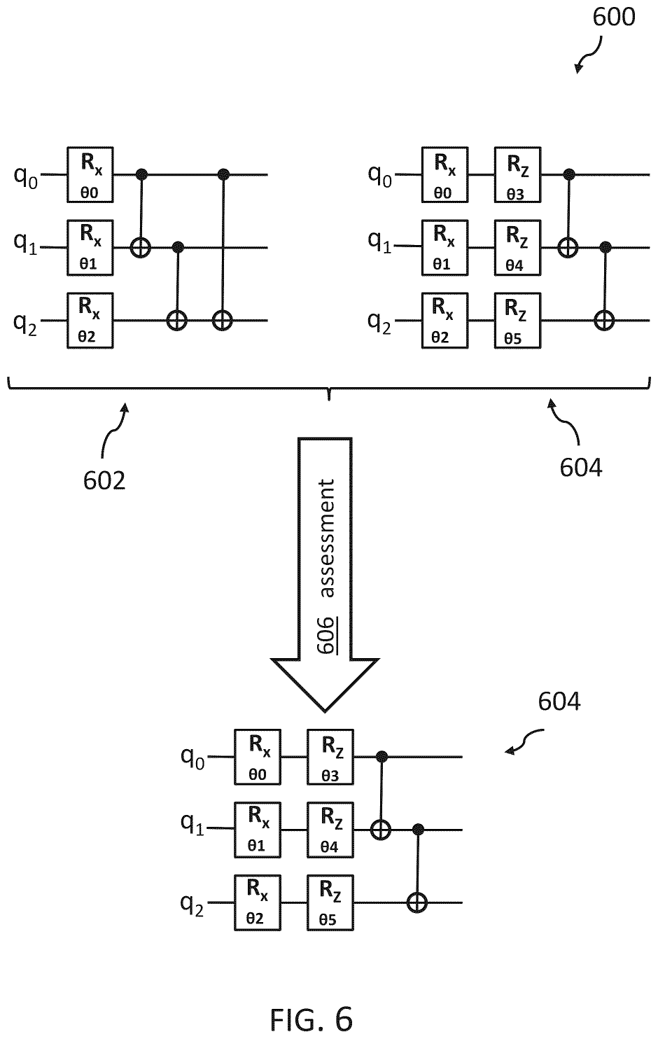

FIG. 6 depicts a selection process 600 of the best performing quantum circuit according to at least one embodiment. 602 and 604 show two different quantum circuits and/or quantum circuit ansatzes. These two quantum circuits may represent a larger set of different quantum circuits. These quantum circuits may execute a certain task, e.g., the predefined problem. The quantum circuits are assessed, 606, in particular, by a classic or digital computer (not shown). In the example shown, the quantum circuit 604 turns out to be the higher performing quantum circuit. The performance may be expressed as expressiveness, reached energy, time to reach the energy equilibrium, and so on.

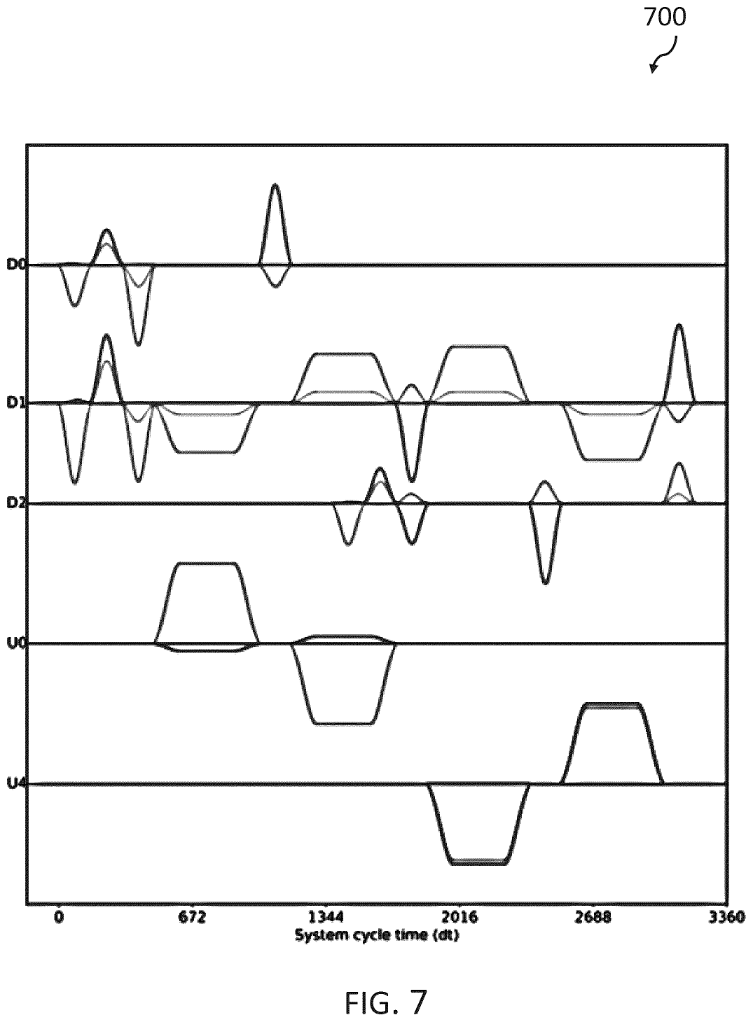

Then, the selected quantum circuit is scheduled which may result in the pulse schema 700 shown in FIG. 7. It should be noted that the underlying pulses may have a high complexity.

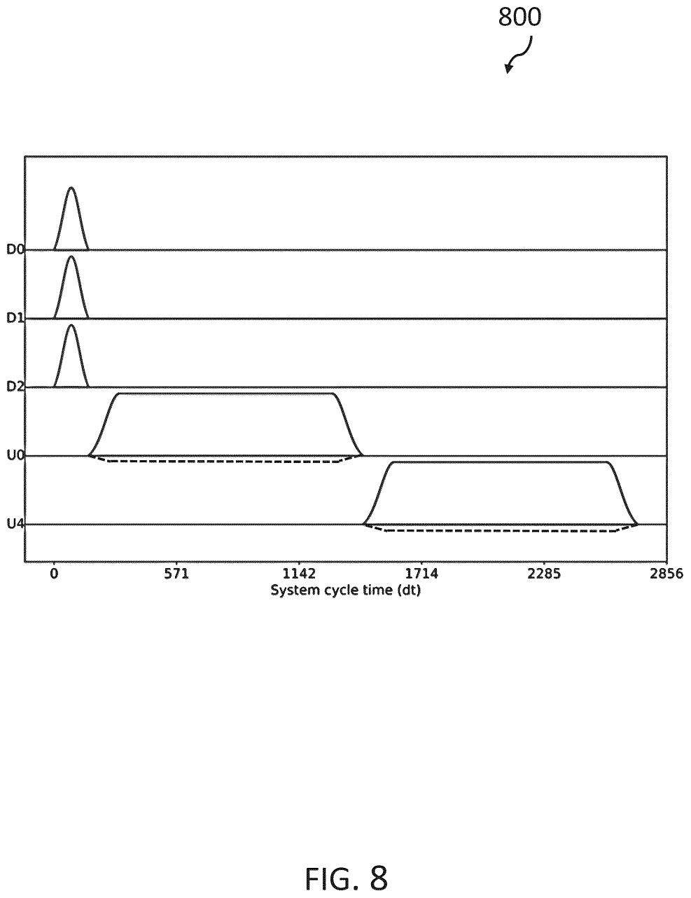

Through the pulse parametrization, the scheduled quantum circuit may be simplified at the pulse level, e.g., by the pulse parametrization, such that the amplitude and the duration of the cross-resonance tones can be controlled. The result 800 is shown in FIG. 8. Here, echoes and rotaries are now removed.

This schedule parametrization and simplification—as illustrated—show that significant reductions in scheduled duration can be achieved. In fact, here the duration of the cross-resonance (CR) tones may be about the same. Hence, making the amplitude and duration of the CR tones parametric, may allow the VQE to shorten the schedules (or better the coherence usage) at the expense of other errors such as, but not limited to, Stark-induced phase shifts (which can be absorbed in other variational parameters). In addition, fewer errors may be possible.

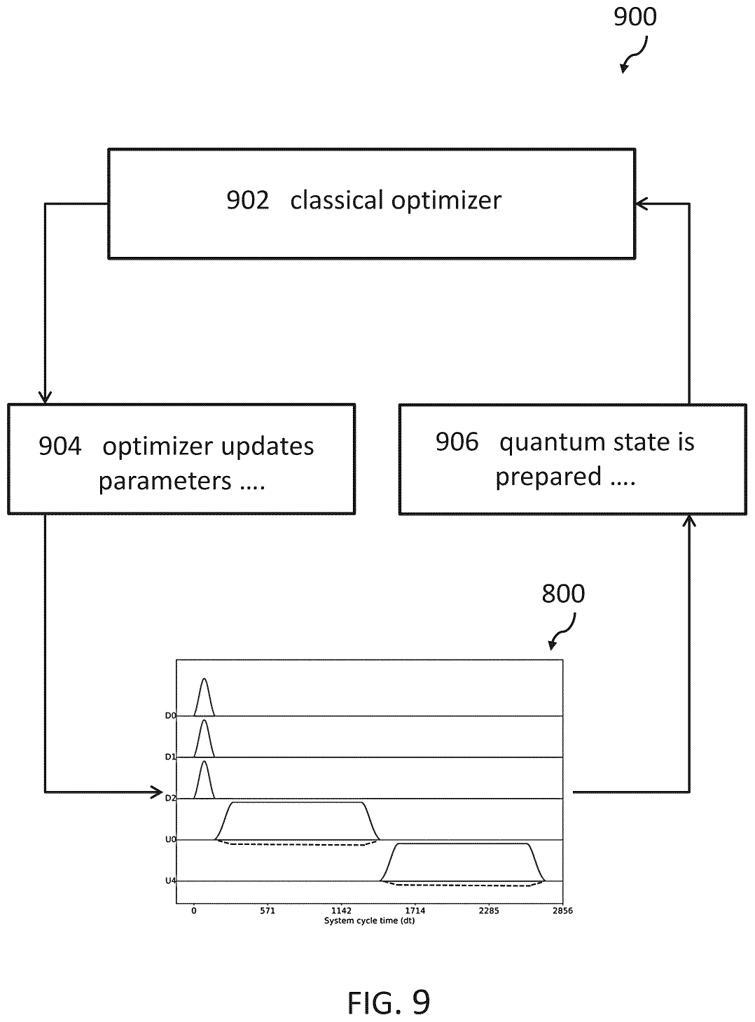

FIG. 9 depicts a proposed concept as a loop process 900. The parametrized quantum circuit may be used to solve the given variational problem by providing the pyramid to us and the corresponding expectation values to a classical optimization loop. The classical optimizer 902 uses a classic or digital computer. Thereby, the classical optimizer 902 updates, 904, the parameters of the schedule, resulting in, e.g., the scheduled pulses 800. Based on this, the quantum state may be prepared, 906, and the corresponding expectation value was sent to the classical optimizer 902. It should be noted that this loop process can be executed in real-time meaning that purse cycle less than a second may be required.

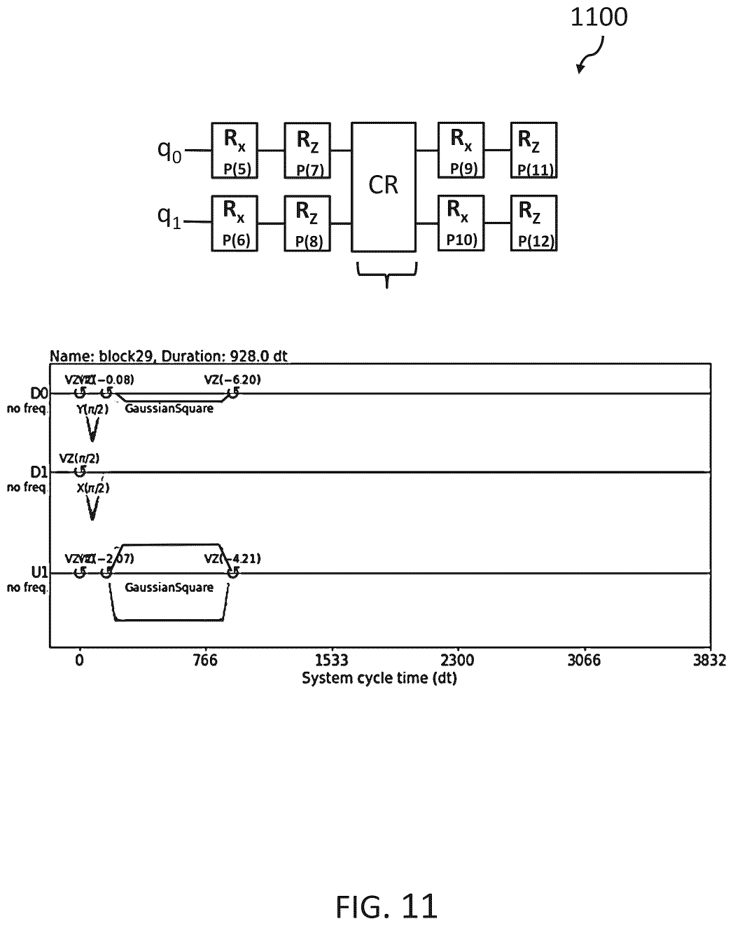

FIG. 10 and FIG. 11 depict a practical proof of concept for the inventive concept according to at least one embodiment. To exemplify the inventive concept the variational quantum eigensolver has been run for the hydrogen (H₂) molecule at the equilibrium bond length. While the gate-based approach 1000 of FIG. 10 and the original CNOT schedule parametrizes these single-qubit rotations, the pulse-based approach may use the parametrized cross-resonance gate which may be simplified by removing the echo structures. The cross-resonance gate may have five parameters, namely the duration of the pulse and the complex amplitudes of the cross-resonance and the rotary pulses.

The optimized pulse-based approach 1100, shown in FIG. 11, is about 4 times shorter than the original CNOT schedule of FIG. 11, namely, about 800 dt vs. about 3600 dt. Here, “dt” may be the duration of a single sample of the arbitrary waveform generator.

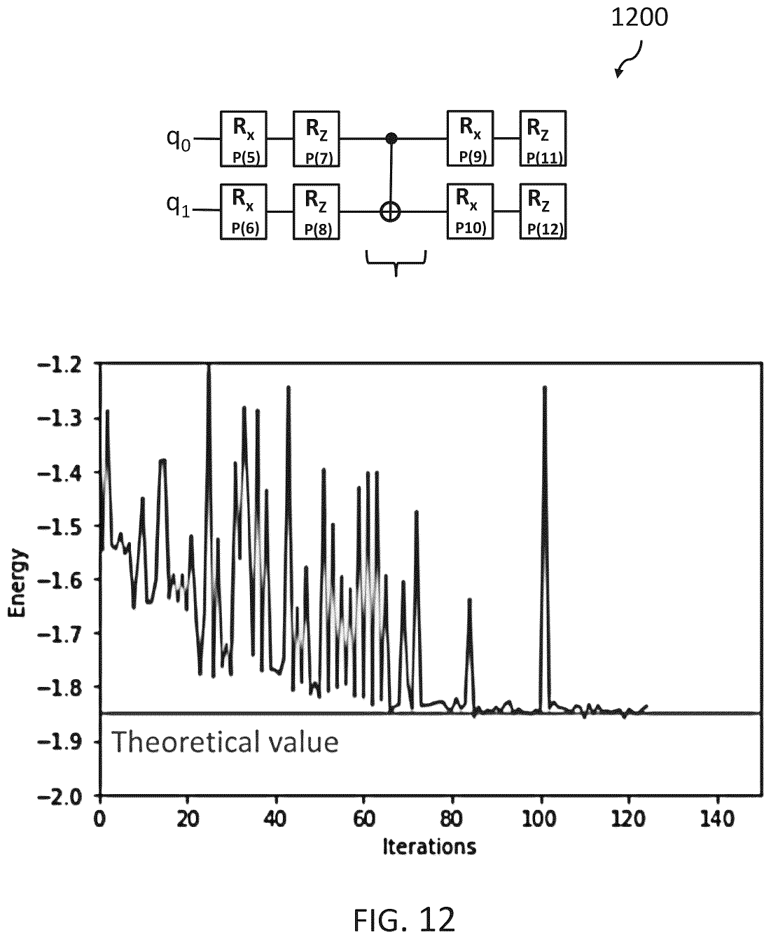

FIG. 12 depicts an illustration 1200 of the practical impact of the proposed concept. Starting with an initial schedule for the CNOT gate, a simplified and optimized cross-resonance gate was prepared that allowed to successfully find the ground state of an H₂ molecule. The graph and the lower part of FIG. 12 may be the intermediate value from the optimization of 8 single qubit rotations parameters and five cross-resonance gate parameters. The COBYL optimization routine was used in this example. Alternatively, the SPSA optimizer routine—or any other suitable optimizer—may be used instead.

This clearly supports the claim that it may be possible to perform variational algorithms in a resource efficient way. The here proposed concept makes better use of the net coherence time and keeps the number of optimization parameters and their control.

On noisy hardware, traditional variational schemes will be limited to the coherence time of the hardware. A pulse-based approach may make a better use of the limited coherence time than a circuit-based approach, thus approaching a potential quantum advantage.

Since the proposed concept favors shorter pulses, it may—in the long-term—also increase the circuit layer operations per second (CLOPS). This is crucial for applications that require many shots such as VQEs. Therefore the proposed concept has the potential to reduce the total execution time of the VQE which may be crucial to gain a quantum advantage.

VQE also provides a great opportunity to benchmark quantum computers and it can provide information and insights on hardware limitations. Using the proposed approach, one can scope hardware needs (such coherent vs. incoherent error trade-offs) and evaluate the possibility of developing new hardware protocols (e.g., gates) that can be specifically used for the simulation of a specific system such as a molecule.

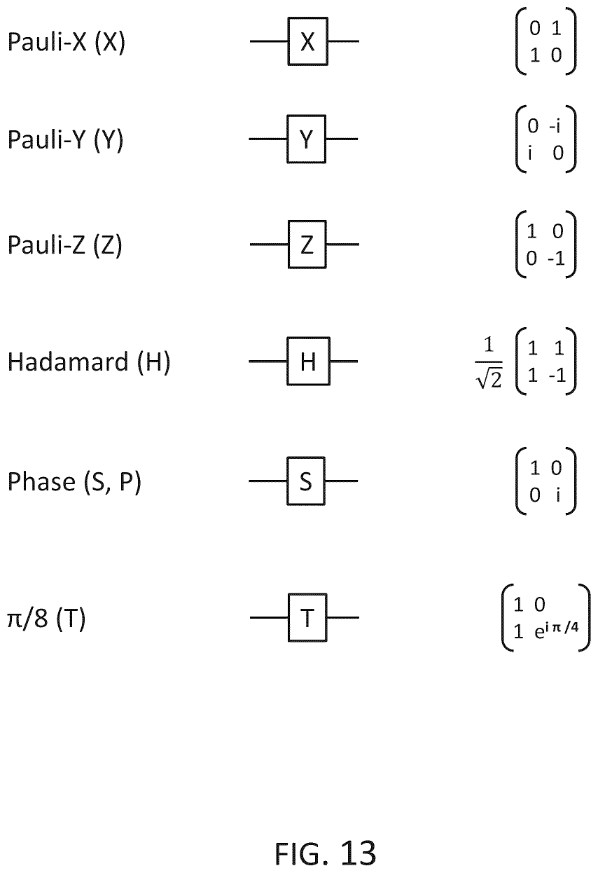

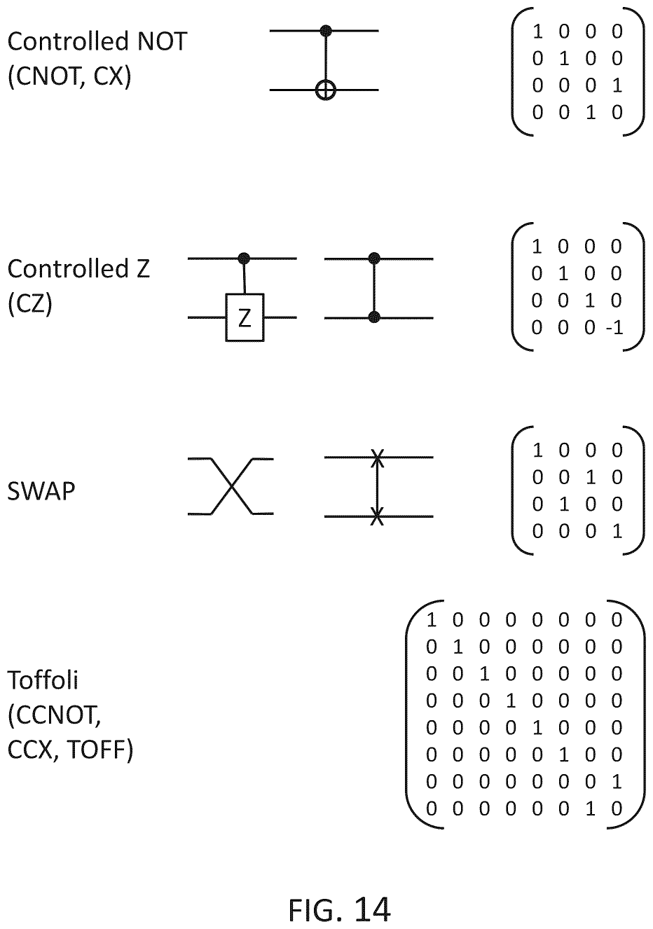

FIGS. 13 and 14 show exemplary qubit operations that may be used in embodiments, in particular to define qubit operation of quantum circuits when defining the quantum feature map.

Shown are possible matrix representations of the unitary operations implemented according to embodiments. For example, the Pauli matrices (X, Y, Z) are realized as X-, Y-, Z-gates acting on one qubit of the quantum computer. They represent rotations of the 2-dimensional complex space defined for each qubit. The parameter θ, for example, can be implemented in the quantum computer by adding corresponding gates corresponding to SU(2)-rotations with the arguments θ. The Hadamard gate corresponds also to a unitary operation involving one qubit and may be used to initialize the zero state (mixed states are generated). The gates S, P and T are mathematically phase operations that change the phase of one of the two states of one qubit.

More complex operations implemented by circuits in the quantum computer are the 2-qubit gates: Controlled Not (CNOT) gate and the Controlled Z (CZ) gate, which may likewise be represented by the depicted matrices. The SWAP gate exchanges two qubits whereas the Toffoli-gate may be an exemplary three qubit gate.

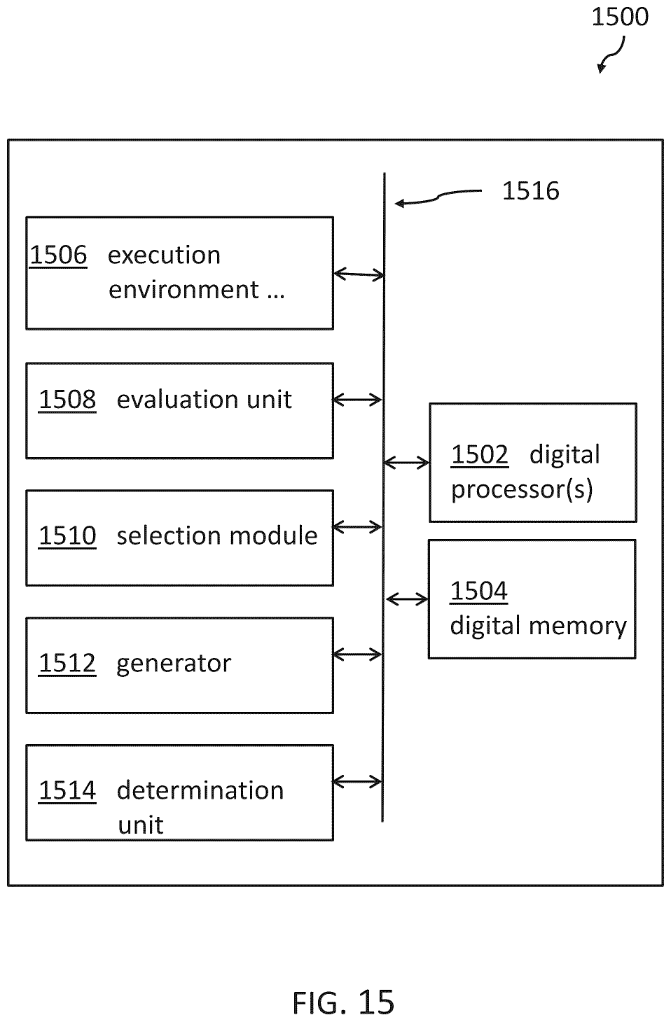

FIG. 15 depicts a block diagram of an embodiment of the quantum information processing system 1500 for executing a resource-efficient pulse-based variational quantum circuit running on a selected quantum hardware to solve a given problem (e.g., the given predefined problem).

The system 1500 comprises an execution environment for the selected quantum hardware adapted for executing a plurality of different quantum circuits using the selected quantum hardware for the given predefined problem to be solved. The system 1500 comprises a digital processor 1502 operationally coupled to a digital memory 1504 which may store instructions, which when executed, controls the following components: (ii) an evaluation unit 1508, controlled by a digital processor 1502, wherein the evaluation unit 1508 is operational to evaluate a performance of each of the plurality of executing quantum circuits (not shown but being operational in a loop process with the digital computer) in a (i) controlled execution environment 1506; (ii) a selection module 1510 selecting, controlled by the digital processor 1502, wherein the selection module 1510 is operational to select a best performing one of the plurality of quantum circuits; (iv) a generator 1512, controlled by the digital processor 1502, wherein the generator 1512 is operative for generating a pulse sequence having a pulse schedule to the selected quantum hardware and the given problem for the best performing quantum circuit of the plurality of different quantum circuits, and (v) a determination unit 1514, controlled by a digital processor 1502, wherein the determination unit 1514 is operational to determine a simplified pulse schedule, thereby producing an efficient pulse-based schedule that acts as a pulse-based variational form for the best performing quantum circuit.

It shall also be mentioned that all functional units, modules and functional blocks—in particular, the digital processor 1502, the digital memory 1504, and the execution environment 1506, the evaluation unit 1508, the selection module 1510, the generator 1512, and the determination unit 1514—may be communicatively coupled to each other for signal or message exchange in a selected 1:1 manner. Alternatively the functional units, modules and functional blocks can be linked to a system internal bus system 1516 for a selective signal or message exchange.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed at to violate or encourage the violation of any local, state, federal or international law with respect to privacy protection.

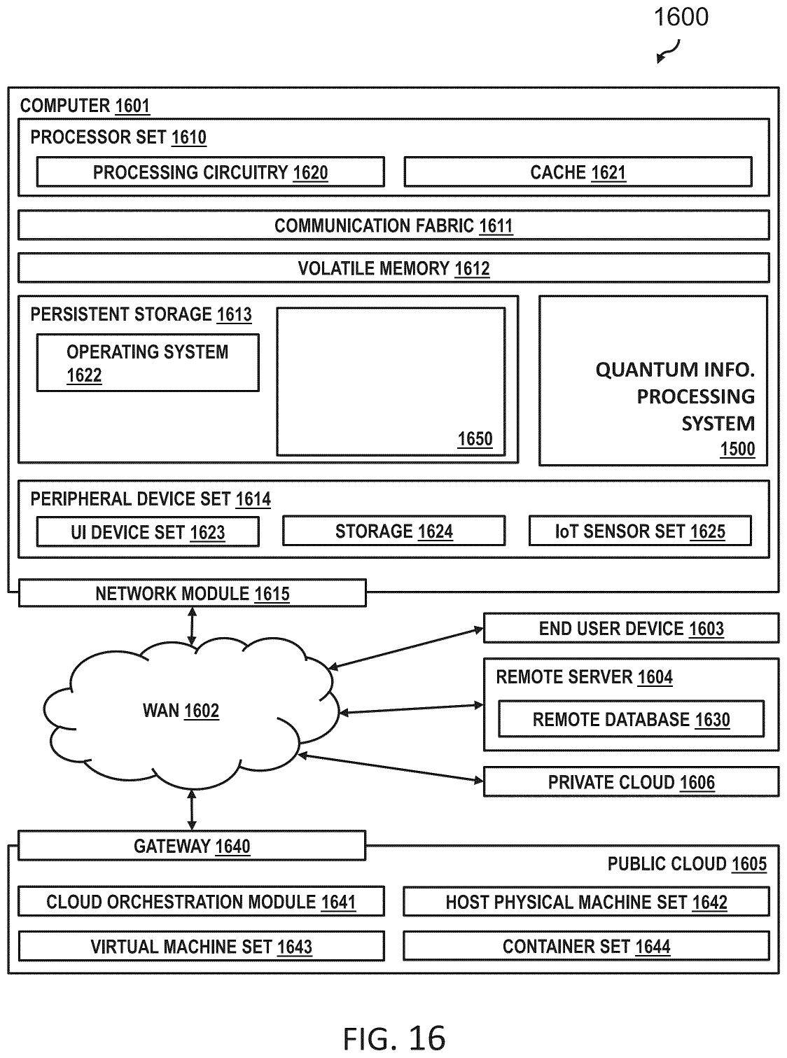

FIG. 16 shows a computing environment 1600 comprising an example of an environment for the execution of at least some of the computer code involved in performing the inventive methods, such as the computer-implemented method for a resource-efficient pulse-based variational quantum circuit running on a selected quantum hardware to solve a given problem 1650.

In addition to block 1650, computing environment 1600 includes, for example, computer 1601, wide area network (WAN) 1602, end user device (EUD) 1603, remote server 1604, public cloud 1605, and private cloud 1606. In this embodiment, computer 1601 includes processor set 1610 (including processing circuitry 1620 and cache 1621), communication fabric 1611, volatile memory 1612, persistent storage 1613 (including operating system 1622 and block 1650, as identified above), peripheral device set 1614 (including user interface (UI), device set 1623, storage 1624, and Internet of Things (IoT) sensor set 1625), and network module 1615. Remote server 1604 includes remote database 1630. Public cloud 1605 includes gateway 1640, cloud orchestration module 1641, host physical machine set 1642, virtual machine set 1643, and container set 1644.

Computer 1601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1630. As is well understood in the art of computer technology, and depending upon the technology, performance of a computer-implemented method may be distributed among multiple computers and/or between multiple locations. On the other hand, in this presentation of computing environment 1600, detailed discussion is focused on a single computer, specifically computer 1601, to keep the presentation as simple as possible. Computer 1601 may be located in a cloud, even though it is not shown in a cloud in FIG. 16. On the other hand, computer 1601 is not required to be in a cloud except to any extent as may be affirmatively indicated.

Processor Set 1610 includes one, or more, computer processors of any type now known or to be developed in the future. Processing circuitry 1620 may be distributed over multiple packages, for example, multiple, coordinated integrated circuit chips. Processing circuitry 1620 may implement multiple processor threads and/or multiple processor cores. Cache 1621 is memory that is located in the processor chip package(s) and is typically used for data or code that should be available for rapid access by the threads or cores running on processor set 1610. Cache memories are typically organized into multiple levels depending upon relative proximity to the processing circuitry. Alternatively, some, or all, of the cache for the processor set may be located “off chip.” In some computing environments, processor set 1610 may be designed for working with qubits and performing quantum computing.

Computer readable program instructions are typically loaded onto computer 1601 to cause a series of operational steps to be performed by processor set 1610 of computer 1601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1621 and the other storage media discussed below. The program instructions, and associated data, are accessed by processor set 1610 to control and direct performance of the inventive methods. In computing environment 1600, at least some of the instructions for performing the inventive methods may be stored in block 1650 in persistent storage 1613.

Communication Fabric 1611 is the signal conduction paths that allow the various components of computer 1601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 1612 is any type of volatile memory now known or to be developed in the future. Examples include dynamic type random access memory (RAM) or static type RAM. Typically, the volatile memory is characterized by random access, but this is not required unless affirmatively indicated. In computer 1601, the volatile memory 1612 is located in a single package and is internal to computer 1601, but, alternatively or additionally, the volatile memory may be distributed over multiple packages and/or located externally with respect to computer 1601.

Persistent Storage 1613 is any form of non-volatile storage for computers that is now known or to be developed in the future. The non-volatility of this storage means that the stored data is maintained regardless of whether power is being supplied to computer 1601 and/or directly to persistent storage 1613. Persistent storage 1613 may be a read only memory (ROM), but typically at least a portion of the persistent storage allows writing of data, deletion of data and re-writing of data. Some familiar forms of persistent storage include magnetic disks and solid state storage devices. Operating system 1622 may take several forms, such as various known proprietary operating systems or open source Portable Operating System Interface type operating systems that employ a kernel. The code included in block 1650 typically includes at least some of the computer code involved in performing the inventive methods.

Peripheral Device Set 1614 includes the set of peripheral devices of computer 1601. Data communication connections between the peripheral devices and the other components of computer 1601 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 1623 may include components such as a display screen, speaker, microphone, wearable devices (such as goggles and smart watches), keyboard, mouse, printer, touchpad, game controllers, and haptic devices. Storage 1624 is external storage, such as an external hard drive, or insertable storage, such as an SD card. Storage 1624 may be persistent and/or volatile. In some embodiments, storage 1624 may take the form of a quantum computing storage device for storing data in the form of qubits. In embodiments where computer 1601 is required to have a large amount of storage (for example, where computer 1601 locally stores and manages a large database) then this storage may be provided by peripheral storage devices designed for storing very large amounts of data, such as a storage area network (SAN) that is shared by multiple, geographically distributed computers. IoT sensor set 1625 is made up of sensors that can be used in Internet of Things applications. For example, one sensor may be a thermometer and another sensor may be a motion detector.

Network Module 1615 is the collection of computer software, hardware, and firmware that allows computer 1601 to communicate with other computers through WAN 1602. Network module 1615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1615 are performed on the same physical hardware device. In other embodiments (e.g., embodiments that utilize software-defined networking (SDN)), the control functions and the forwarding functions of network module 1615 are performed on physically separate devices, such that the control functions manage several different network hardware devices. Computer readable program instructions for performing the inventive methods can typically be downloaded to computer 1601 from an external computer or external storage device through a network adapter card or network interface included in network module 1615.

WAN 1602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 1603 is any computer system that is used and controlled by an end user (for example, a customer of an enterprise that operates computer 1601), and may take any of the forms discussed above in connection with computer 1601. EUD 1603 typically receives helpful and useful data from the operations of computer 1601. For example, in a hypothetical case where computer 1601 is designed to provide a recommendation to an end user, this recommendation would typically be communicated from network module 1615 of computer 1601 through WAN 1602 to EUD 1603. In this way, EUD 1603 can display, or otherwise present, the recommendation to an end user. In some embodiments, EUD 1603 may be a client device, such as thin client, heavy client, mainframe computer, desktop computer and so on.

Remote Server 1604 is any computer system that serves at least some data and/or functionality to computer 1601. Remote server 1604 may be controlled and used by the same entity that operates computer 1601. Remote server 1604 represents the machine(s) that collect and store helpful and useful data for use by other computers, such as computer 1601. For example, in a hypothetical case where computer 1601 is designed and programmed to provide a recommendation based on historical data, then this historical data may be provided to computer 1601 from remote database 1630 of remote server 1604.

Public Cloud 1605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1605 is performed by the computer hardware and/or software of cloud orchestration module 1641. The computing resources provided by public cloud 1605 are typically implemented by virtual computing environments that run on various computers making up the computers of host physical machine set 1642, which is the universe of physical computers in and/or available to public cloud 1605. The virtual computing environments (VCEs) typically take the form of virtual machines from virtual machine set 1643 and/or containers from container set 1644. It is understood that these VCEs may be stored as images and may be transferred among and between the various physical machine hosts, either as images or after instantiation of the VCE. Cloud orchestration module 1641 manages the transfer and storage of images, deploys new instantiations of VCEs and manages active instantiations of VCE deployments. Gateway 1640 is the collection of computer software, hardware, and firmware that allows public cloud 1605 to communicate through WAN 1602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 1606 is similar to public cloud 1605, except that the computing resources are only available for use by a single enterprise. While private cloud 1606 is depicted as being in communication with WAN 1602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1605 and private cloud 1606 are both part of a larger hybrid cloud.

It should also be mentioned that the quantum information processing system 1500 for executing a resource-efficient pulse-based variational quantum circuit running on a selected quantum hardware to solve a given problem can be an operational sub-system of the computer 1601 and may be attached to a computer-internal bus system. It should also be mentioned, that the quantum part including required control systems of the quantum information processing system 1500 may be operated remotely in a cloud environment, whereas the digital processor and its components for the optimization loop can be located remotely from the quantum part.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method for a resource-efficient pulse-based variational quantum circuit running on a selected quantum hardware to solve a given predefined problem, the method comprising:
controlling an execution of a plurality of different quantum circuits using a selected quantum hardware for a given predefined problem to be solved;
evaluating a performance of each of the plurality of different quantum circuits;
selecting a best performing one of the plurality of quantum circuits;
generating a pulse sequence having a pulse schedule tailored to the selected quantum hardware and the given problem for the best performing one of the plurality of different quantum circuits; and
determining a simplified pulse schedule of the pulse sequence, thereby producing an efficient pulse-based schedule that acts as a pulse-based variational form for the best performing quantum circuit.

2. The method according to claim 1, wherein the evaluation of the performance of each of the plurality of quantum circuits further comprises:
simplifying the given predefined problem.

3. The method according to claim 1, wherein the determination of the simplified pulse schedule comprises:
at least one selected out of a group comprising:
removing at least a pulse from the pulse schedule;
merging at least two pulses in the pulse schedule;
adding pulses to the pulse schedule; and
changing a shape of the pulse.

4. The method according to claim 1, wherein the determining of the simplified pulse schedule comprises:
using a single Gaussian pulse as a replacement for more complex pulse shapes.

5. The method according to claim 1, wherein the determination of the simplified pulse schedule comprises:
reducing an active time for a scheduled pulse.

6. The method according to claim 1, wherein the selected quantum hardware comprises a physical two-qubit gate.

7. The method according to claim 1, wherein the selected quantum hardware uses error correction and/or error mitigation.

8. The method according to claim 1, wherein the quantum circuit is used for a simplified and optimized physical two-qubit gate and a determination of a molecular energy level of a molecule.

9. The method according to claim 1, wherein a COBYLA optimization algorithm or a SPSA optimization algorithm is used the determination of parameters of the simplified pulse schedule.

10. The method according to claim 9, wherein the COBYLA optimization algorithm or the SPSA optimization algorithm is each performed by a digital processor.

11. A quantum information processing system for executing a resource-efficient pulse-based variational quantum circuit running on a selected quantum hardware to solve a given predefined problem, the system comprising:
a digital processor operationally coupled to a digital memory which stores instructions, which when executed, controls the following components:
an execution environment for the selected quantum hardware adapted for executing a plurality of different quantum circuits using the selected quantum hardware for the given predefined problem to be solved;
an evaluating unit, controlled by the digital processor, the evaluation unit being operational to evaluate a performance of each of the plurality of quantum circuits;
a selection module selecting, controlled by the digital processor, the selection module being operational to select a best performing one of the plurality of quantum circuits;
a generator, controlled by the digital processor, the generator being operative for generating a pulse sequence having a pulse schedule to the selected quantum hardware and the given problem for the best performing quantum circuit of the plurality of different quantum circuits; and
a determination unit, controlled by a digital processor, the determination unit being operational to determine a simplified pulse schedule, thereby producing an efficient pulse-based schedule that acts as a pulse-based variational form for the best performing quantum circuit.

12. The system according to claim 11, wherein the evaluating the performance of each of the plurality of quantum circuits also comprises:
simplifying the given predefined problem.

13. The system according to claim 11, wherein the determination of the simplified pulse schedule comprises:
at least one selected out of a group comprising:
removing at least a pulse from the pulse schedule;
merging at least two pulses in the pulse schedule;
adding pulses to the pulse schedule; and
changing a shape of the pulse.

14. The system according to claim 11, wherein the determination of the simplified pulse schedule also comprises:
using a single Gaussian pulse as a replacement for more complex pulse shapes.

15. The system according to claim 11, wherein the generation of the simplified pulse schedule comprises:
reducing a time for the scheduled pulse.

16. The system according to claim 11, wherein the selected quantum hardware comprises a physical two-qubit gate.

17. The system according to claim 11, wherein the selected quantum hardware uses error correction and/or error mitigation.

18. The system according to claim 11, wherein the quantum circuit is used by the selected quantum hardware for a simplified and optimized physical two-qubit gate and a determination of a molecular energy level of a molecule.

19. The system according to claim 11, wherein a COBYLA optimization algorithm or a SPSA optimization algorithm is used for a determination of parameters of the simplified pulse schedule.

20. A computer program product for a resource-efficient pulse-based variational quantum circuit running on a selected quantum hardware to solve a given predefined problem, the computer program product comprising a computer readable storage medium having program instructions embodied therewith, the program instructions being executable by one or more computing systems or controllers to cause the one or more computing systems to perform a method comprising:
controlling an execution of a plurality of different quantum circuits using the selected quantum hardware for the given predefined problem to be solved;
evaluating a performance of each of the plurality of different quantum circuits;
selecting a best performing one of the plurality of quantum circuits;
generating a pulse sequence having a pulse schedule tailored to the selected quantum hardware and the given problem for the best performing one of the plurality of different quantum circuits; and
determining a simplified pulse schedule of the pulse sequence, thereby producing an efficient pulse-based schedule that acts as a pulse-based variational form for the best performing quantum circuit.
